(19) United States
(12) Patent Application Publication
(10) Pub. No.: US 2025/0239853 A1
(43) Pub. Date: Jul. 24, 2025

(54) SYSTEM AND A METHOD FOR MANAGING PEAK POWER CONSUMPTION

(71) Applicant: Logan T. Pleasant, Tahlequah, OK (US)

(72) Inventor: Logan T. Pleasant, Tahlequah, OK (US)

(21) Appl. No.: 19/032,561

(22) Filed: Jan. 21, 2025

Related U.S. Application Data
(60) Provisional application No. 63/622,766, filed on Jan. 19, 2024.

(51) Int. Cl. H02J 3/14; H02J 13/00

(52) U.S. Cl. CPC H02J 3/14; H02J 13/00002; H02J 13/00006; H02J 2310/12

(57) ABSTRACT

System for managing energy demand including electrical breaker box, electric vehicle (EV), and heating, ventilation, and air conditioning (HVAC) unit(s). A device imbedded in the breaker box senses the energy level in the environment for determining if the electrical demand is at/near a level where active controllable loads need to be turned off, or inactive controllable loads need to be restrained to stay off. An EV charger control electrically connects with the EV and determines an operational state of the HVAC. When the HVAC is not operational, the EV charger control allows charging of the EV, unless overridden by the EV driver. When the HVAC is operating in a high-power consuming mode, the EV controller does not allow charging of the EV. If energy demand is too high, breaker box sensor will send command to restrict charging of the EV and/or will cycle the HVAC to reduce the energy demand.

The present application claims the benefit of U.S. Provisional Application No. 63/622,766, filed Jan. 19, 2024; all of which is incorporated herein by reference in its entirety.

### FIELD OF THE INVENTION

The present invention relates generally to energy optimization. More specifically, the present invention relates to monitoring an operational state of equipment and managing peak power consumption at a building.

### BACKGROUND OF THE INVENTION

Several devices and technologies have been used to monitor in-home electrical usage, control electric vehicle (EV) charging, and manage heating, ventilation, and air conditioning (HVAC) operation. Examples of the devices and technologies include, but not limited to, energy management systems, thermostats, EV controllers, smart grid integration, etc. The devices and technologies help to monitor and control electrical devices, but don't really focus on minimizing peak electrical demand in the facility. Further, the energy management systems typically only provide data, such as real-time or historic energy consumption, in order to facilitate an end user in making informed decisions about energy usage.

Several devices and technologies for monitoring in-home electrical usage have been disclosed in the past. One such example is disclosed in a United States Granted U.S. Pat. No. 10,338,112, entitled “Communication of historical and real-time information about devices in a building” (“the '112 Patent”). The '112 Patent discloses that electrical usage of devices in a building may be monitored to provide information about the operation of the devices to a user. The information communicated to a user may include historical information that is retrieved from a server and real-time information that is received from a power monitoring device. The historical information may be transmitted to the user device over a first network connection where the historical information is retrieved using an identifier received from the user device. The real-time information may be received from a power monitoring device and transmitted to the user device over a second network connection.

Another example is disclosed in a United States Granted U.S. Pat. No. 9,577,291, entitled “Coordinated control of electric vehicle charging and HVAC” (“the '291 Patent”). The '291 Patent discloses a system and method include receiving a temperature signal from a temperature sensor, controlling operation of an air conditioner condenser, and controlling an electric vehicle charger to operate to charge an electric vehicle battery only when the air conditioner condenser is not running.

Yet another example is disclosed in a PCT Publication No. 2023284988, entitled “An electric vehicle hybrid air conditioning system configured for charging an electric vehicle” (“the '988 Publication”). The '988 Publication discloses an electric vehicle hybrid air conditioning system configured for charging an electric vehicle is described. The electric vehicle hybrid air conditioning system comprises at least one air conditioning unit for conditioning a space or medium, at least one electrical vehicle supply equipment (EVSE) for charging at least one electric vehicle and at least one control means for controlling the at least one air conditioning unit and the at least one electrical vehicle supply equipment.

Although the above discussed disclosures are useful, they do not directly focus on energy demand reduction. For instance, the energy management systems are capable of monitoring the energy usage of the devices such as EV and HVAC within the home. The controller circuits and the energy management systems operate in isolation and do not solve the problem of managing peak power consumption (demand) in the home effectively. Further, most of the available solutions for managing peak power consumption are internet based and thus have the potential to fail locally and en masse and/or may require manual intervention by a user. Further, many of the control devices and the energy management systems communicate over consumer Wi-Fi and as a result are more at risk to hacking by a third party.

Therefore, there is a need in the art to provide an improved system for managing electrical demand (i.e. average peak power consumption) by monitoring in-home electrical usage, and controlling the timing and level of large loads in the home, such as EV charging and HVAC operation.

### SUMMARY

It is an object of the present subject matter to provide a system that improves upon the drawbacks of known electric vehicle (EV) controllers and energy management systems.

It is another object of the present subject matter to provide a system for managing the demand (i.e. average peak power consumption) in an environment based on operational states of equipment like an electric vehicle (EV) charger and a heating, ventilation, and air conditioning (HVAC) unit installed in the environment.

In order to achieve one or more objects, the present subject matter provides a system for managing demand in an environment. The environment includes a level 2 EV charger and an HVAC unit. An EV controller electrically connects to the EV charger and determines an operational state of the HVAC from a signal obtained from an HVAC controller. When it is determined that the HVAC is not operational, the EV controller allows charging of the EV. Alternatively, when it is determined that the HVAC is operating in a high power consuming mode, the EV controller does not allow charging of the EV.

A controller circuit for managing operation of respective equipment is connected to a server. The server obtains information on the operational status of each piece of monitored equipment, such as that of the HVAC and the EV charger, for the purpose of making that information available to other devices in the system, such as the breaker panel sensor or the auxiliary communication module that communicates to the web server.

In one advantageous feature of the present subject matter, an EV controller restricts charging of the EV when the HVAC unit is operating in a high power consumption mode. This ensures that additional strain is not applied through the power transformer supplying power to the environment in which the HVAC unit and the EV operate.

The features and advantages of the subject matter here will become more apparent in light of the following detailed description of selected embodiments, as illustrated in the accompanying FIGURES. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

A more complete understanding of the invention and the many attendant advantages thereof will be readily appreciated as the same becomes better understood by reference to the following detailed description, when considered in connection with the accompanying drawings wherein:

FIG. 1 shows a block diagram of a typical home electrical system for supplying and monitoring power consumption in an environment, in accordance with prior art;

FIG. 2 illustrates a block diagram of an EV controller, in accordance with one embodiment of the present subject matter;

FIG. 3 illustrates a circuit diagram of the EV controller, in accordance with one embodiment of the present subject matter;

FIG. 4 illustrates a method for controlling the EV charging based upon the status of the HVAC unit, in accordance with another embodiment of the present subject matter;

FIG. 5 illustrates a block diagram of a proposed system for managing electrical demand in an environment, in accordance with the proposed embodiment of the present subject matter;

FIG. 6 illustrates a method for sensing and controlling the HVAC system, in accordance with the proposed embodiment of the present subject matter;

FIG. 7 illustrates a method of for managing the demand (i.e. average peak power consumption) in an environment, in accordance with the proposed embodiment of the present subject matter;

FIG. 8 illustrates the logic for categorizing each large electrical load and creating a repository of key trend data for such loads for later statistical analysis, in accordance with another embodiment of the present subject matter;

FIG. 9 illustrates a method of active demand period prediction using a prediction algorithm, in accordance with the proposed embodiment of the present subject matter; and

FIG. 10 illustrates a method of future (next) demand period prediction using a prediction algorithm, in accordance with the proposed embodiment of the present subject matter.

### DETAILED DESCRIPTION

The following detailed description set forth below in connection with the appended drawings is intended as a description of exemplary embodiments in which the presently disclosed subject matter may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed system. However, it will be apparent to those skilled in the art that the presently disclosed subject matter may be practiced without these specific details. In some instances, well-known structures and devices are shown in functional or conceptual diagram form in order to avoid obscuring the concepts of the presently disclosed system.

In the present specification, an embodiment showing a singular component should not be considered limiting. Rather, the subject matter preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present subject matter encompasses present and future known equivalents to the known components referred to herein by way of illustration.

Although the present subject matter provides a description of a system, it is to be further understood that numerous changes may arise in the details of the embodiments of the system. It is contemplated that all such changes and additional embodiments are within the spirit and true scope of this disclosure.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure.

The present subject matter discloses a system for managing energy demand (i.e. average peak power consumption) in an environment. The environment includes a level 2 electric vehicle (EV) charger, an electric vehicle (EV) and a heating, ventilation, and air conditioning (HVAC) unit. An EV controller electrically connected with the EV charger determines the operational state of the HVAC from a signal obtained from a server via an HVAC controller. When it is determined that the HVAC is not operational, the EV controller allows charging of the EV. Alternatively, when it is determined that the HVAC is operating in a high power consuming mode, the EV controller does not allow charging of the EV.

A person skilled in the art understands that the electrical demand (i.e. average peak power consumption) indicates a maximum average value of power that is drawn by one or more equipment installed in an environment, such as a home, as seen by the source of energy, such as the electrical grid, over a defined period of time, typically 15 minutes, 30 minutes or 1 hour. The maximum demand may be a limit established by past electrical consumption, or may be explicitly defined by a user to prevent overconsumption of power during any period of time which may result in higher electric bills. Additionally, or alternatively, such maximum value of demand may be defined based on a maximum output value of power in a given period that can be delivered by a power transformer supplying electrical power to the environment.

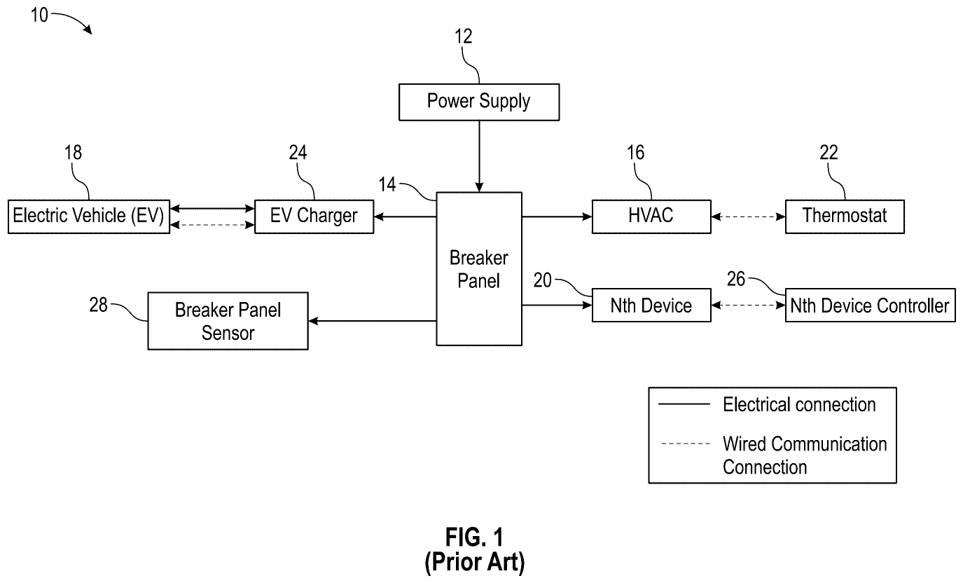

Various features and embodiments of a system for managing demand are explained in conjunction with the description of FIGUREs (FIGS. 1-10.

FIG. 1 shows a block diagram of a typical home electrical system for supplying and monitoring power consumption in an environment 10, in accordance with prior art. Environment 10 includes a power supply 12 such as a grid supplying AC power. Grid 12 supplies energy to environment or home 10 through a breaker panel 14 serving electric equipment such as heating, ventilation, and air conditioning (HVAC) unit 16, Electric Vehicle (EV) 18, and other electrically powered devices (commonly represented as Nth device 20). AC power is available to each piece of electrical equipment, but the status (on/off) is managed through a respective controller circuit. For example, AC power is supplied to HVAC unit 16 only when a controller (such as a thermostat 22, switch or some other similar device) signals the unit to turn on and consume energy., to EV 18 via an EV charger 24, and to Nth device 20 via a Nth device controller 26, respectively.

Environment 10 further includes a breaker panel sensor 28 capable of monitoring consumption of energy by each equipment present in environment 10.

Further, EV charger 24 is capable of charging EV 18 using AC power received via breaker panel 14. As known, EV charger 24 connects to EV 18 via a cable having an EV charging gun that connects to EV 18 via a plugin port/charging interface.

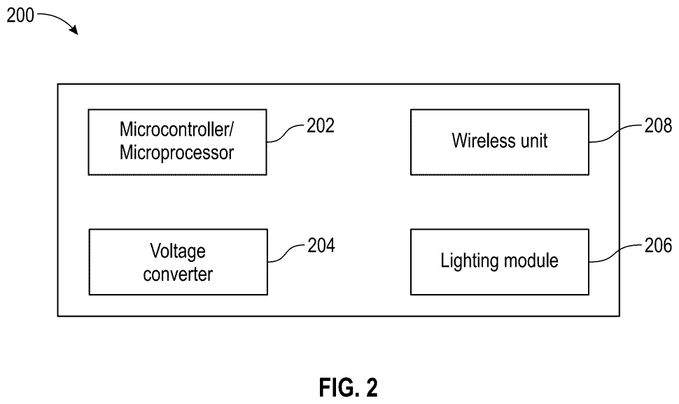

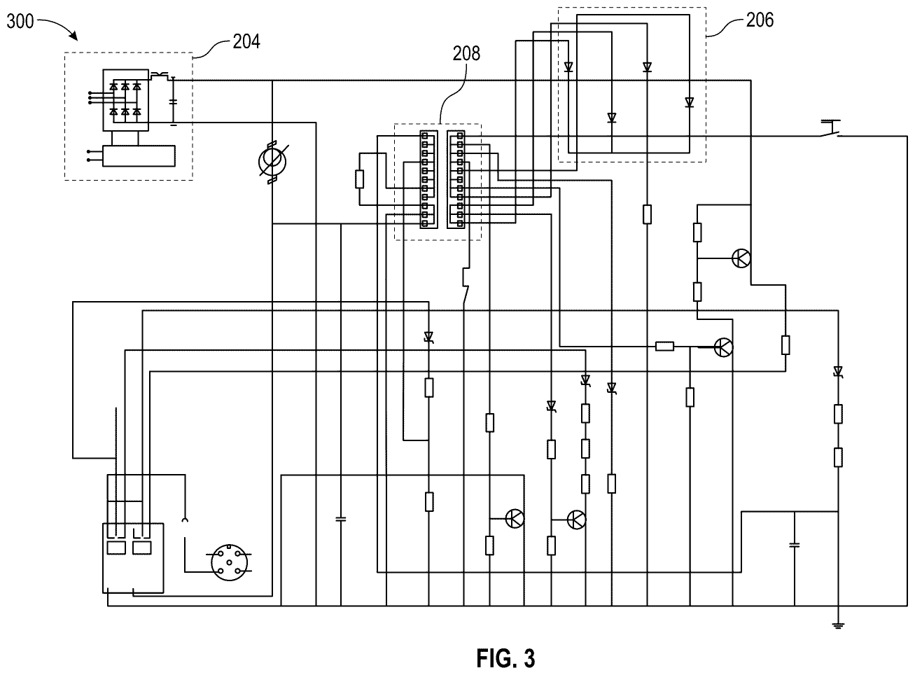

FIG. 2 shows a block diagram of an EV charge controller 200, in accordance with one embodiment of the present subject matter. FIG. 3 shows a circuit diagram 300 of the EV charge controller 200, in accordance with one embodiment of the present subject matter. Referring now to FIG. 2 and FIG. 3, components and functioning of components of EV charge controller 200 is described. The EV controller 200 includes a microcontroller/microprocessor 202 capable of storing and executing program instructions for operating the EV charge controller 200. Further, the EV charge controller 200 includes a voltage converter 204, a lighting module 206, and a wireless unit 208. The voltage converter 204 includes a step-down transformer for converting 120 Volts (V) AC to 12V AC. The voltage converter 204 includes a rectifier circuit (not shown) for converting 12V AC to 12V DC. Further, a voltage regulator, such as IC 7805 is used for conversion of the 12V DC to 5V DC. The lighting module 206 includes one or more light-emitting diodes (LEDs) capable of indicating control status of EV charge controller 200. For example, the LEDs indicate controller power status, HVAC active, charging reduction override active, charging in progress, and charging complete status. The wireless unit 208 transmits data packets to and receives data packets from a remote server. The EV charge controller 200 further includes transistors, resistors, relays and diodes, as shown in FIG. 3, for suitable biasing and operation of components described above.

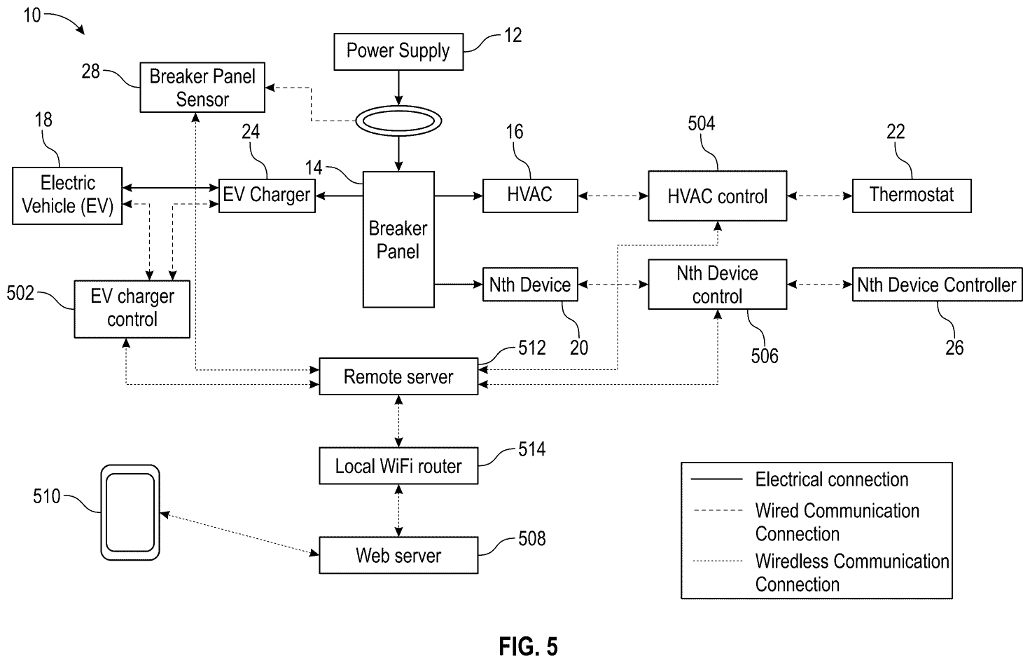

Referring to FIG. 5, each controller circuit i.e. the HVAC controller, the EV charge controller, and the Nth device controller 26 communicatively connect to a server. This remote server connects to each controller circuit via a private and secure local wireless network created by the remote server. The local wireless network includes a short-range network such as Wireless Fidelity (Wi-Fi), Bluetooth, ZigBee, Radio-frequency Identification (RFID), Near Field Communication (NFC) and so on. The network may either be a dedicated network or a shared network. Shared network represents an association of the different types of networks that use variety of protocols, for example, Hypertext Transfer Protocol (HTTP), Transmission Control Protocol/Internet Protocol (TCP/IP), Wireless Application Protocol (WAP), and the like, to communicate with one another. The remote server receives information from each controller circuit upon the status change of a controller. The information may be received as data packets indicating operational status of each equipment. This way, the web server obtains information such as type of device in use, the duration the device is ON, etc. The information helps in scheduling operation of one or more devices for managing peak power consumption in the environment 10.

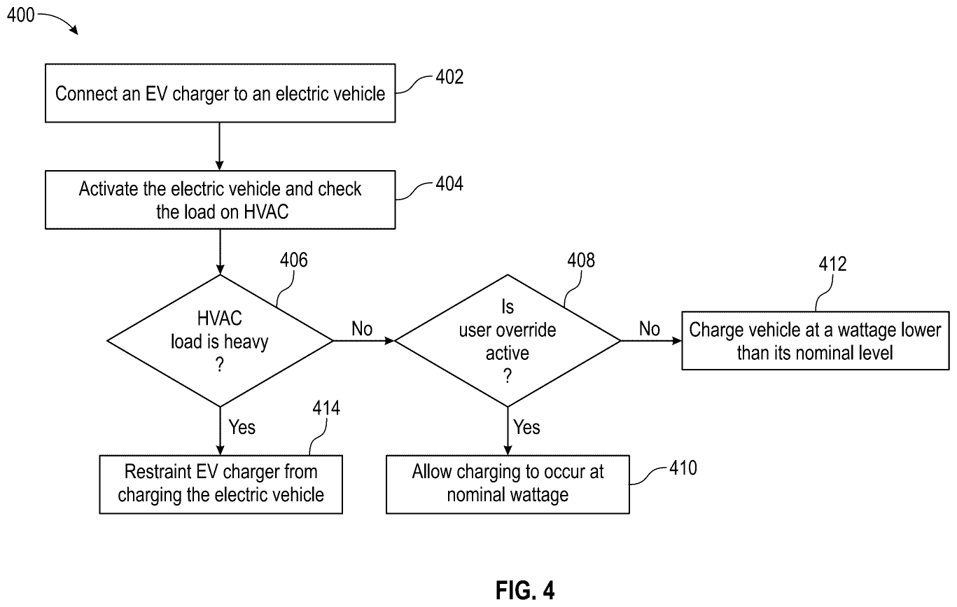

FIG. 4 shows a method 400 for controlling the charging of the EV based upon the status of the HVAC unit in the environment 10 (illustrated in FIG. 5), in accordance with one embodiment of the present subject matter. The order in which method 400 is described should not be construed as a limitation, and any number of the described method blocks can be combined in any order to implement method 400 or alternate methods. Additionally, individual blocks may be deleted from method 400 without departing from the spirit and scope of the subject matter described herein. Furthermore, method 400 can be implemented in any suitable hardware, software, firmware, or combination thereof. However, for ease of explanation, in the embodiments described below, method 400 may be implemented using the above-described controller circuits, such as the EV charge controller.

Method 400 begins at step 402. At step 402, a user connects/installs EV charger 24 to EV 18. Here, EV 18 initializes and awaits EV charger 24 to supply energy. Thereafter, the EV charger control 502 activates and the remote server 512 relays the status of the HVAC unit 16, at step 404. The details of the load on the HVAC unit 16 i.e. the operational status of HVAC unit 16 is obtained by remote server 512 from HVAC control 504 installed near the HVAC unit 16. The operational status of HVAC unit 16 indicates its ON or OFF state for any of the multiple potential parts of the system, such as the air conditioner, heat, blower fan and if applicable any back-up or auxiliary source of heat including multiple stage backup. At step 406, it is determined if HVAC load is heavy, i.e. using significant kilowatts of electricity. When HVAC load is determined not to be heavy, EV charger control 502 checks to see if the user has placed a restraint override in effect, at step 408. If the override is in effect, then EV 18 is allowed to draw energy at the nominal level of the EV charger 24, at step 410. If the override is not in effect then the EV 18 can charge, but at a reduced Wattage as determined by the demand minimization logic in the Breaker Panel Sensor 28 which is then communicated via the remote server 512 to the EV charger control 502 as indicated in step 412. Alternatively, at step 406, when it is determined that HVAC unit 16 load is heavy, EV charger control forces the EV charger 24 to electrically disconnect from EV 18 to prevent charging of EV 18, at step 414.

Subsequently, operational status of HVAC unit 16 is monitored at regular intervals by the EV charger control 502, as shown at step 404 until it is identified that the HVAC unit 16 load is either heavy or not heavy. Further, charging of EV 18 is continued, as shown at step 410 or at step 412 until the battery pack of EV 18 gets completely charged or HVAC unit 16 load becomes heavy. In this manner, when HVAC unit 16 is operating with a significant kilowatt energy consumption, charging of EV 18 is not allowed in order to minimize the energy demand in environment 10. This prevents electrical stress on a power source, for example a region of the power grid or more locally a power transformer supplying electrical power in environment 10.

Although the description of FIG. 4 is provided by considering operation of HVAC unit 16 and EV 18 in environment 10 of FIG. 5, it must be understood that monitoring and controlling the operational state of other heavy power consuming devices like microwave heater, and water heaters (cumulatively shown as Nth device 20 in FIG. 1) could be similarly considered, just as charging of EV 18, to manage peak power consumption in any environment by establishing a hierarchy of control priority.

In one embodiment, HVAC control 504 implements a predetermined on/off cycle as determined necessary by the breaker panel sensor 28. The predetermined cycle length of the HVAC controller prevents frequent transitioning of HVAC compressor (if used) which could damage the compressor motor. The purpose of the HVAC cycling is to manually impose a reduced duty cycle of any or all of the functions of the HVAC system, thereby reducing the electrical demand (i.e. average energy consumption) over a specific period of time.

FIG. 5 shows a block diagram of a proposed system for managing electrical demand in an environment 500, in accordance with the proposed embodiment of the present subject matter. In addition to the equipment shown in FIG. 1, the environment 500 includes EV charger control 502, HVAC control 504, Nth device control 506, and web server 508.

In the present subject matter, Breaker panel sensor 28 continually measures instantaneous energy delivered by the Power Supply 12 to the Breaker Panel 14, and consumed by each equipment in environment 500 continually. From the instantaneous measurements of energy, breaker panel sensor 28 calculates an average demand of energy at predefined time intervals. For example, in accordance with one embodiment of the present subject matter, breaker panel sensor 28 determines average demand of energy within one minute, five minutes, fifteen minutes, and one hour. Breaker panel sensor 28 monitors and records the unique load characteristics of any large load (load in excess of 1000 Watts, for example) such as average run-time, on/off times, duty cycle, etc. to develop historical data sets for each unique load that may be used for statistical analysis for the purpose of short-term peak load (demand) prediction.

In one implementation, EV charger control 502 connects between the cable and the EV charger 24 for the purpose of receiving external control commands that would either limit the level of AC power the EV 18 may draw from the EV charger 24 or to restrain the EV 18 from charging if the HVAC unit 16 has been turned on by a command from the thermostat 22 or other controlling device such as the HVAC control 504. In another implementation the EV charger control may be an internal part of EV charger 24.

In the present subject matter, the EV charger 24 incorporates an external EV charge control system, in accordance with one embodiment of the present subject matter. The EV charge control system acts as a monitor and master control for operating the EV charger 24 in order to charge the EV 18 depending on load consumed by the HVAC unit 16 in the home/building. In other words, the EV charge control system acts as a communication bridge between the EV charger 24 and the EV 18 that operates in conjunction with the native communication between the EV charger 24 and the EV 18.

The environment 500 further includes an auxiliary device imbedded within the remote server 512. The remote server 512 512 and WiFi server 512. The auxiliary device communicatively connects to web server 508 through a consumer Wi-Fi. Web server 508 obtains and stores information that has been relayed to the remote server about the operational status of HVAC unit 16, EV 18, and Nth device 20 from HVAC control 504, EV charger control 502, and Nth device control 506 respectively. Auxiliary device checks status from remote server 512 continually to obtain any new information that is available. If new information is available, auxiliary device will disconnect from the remote server's 512 communication network and establish a connection with the consumer's local WiFi router 514 to establish an internet connection to the web server 508 and then deposits the information on the web server. The auxiliary device then disconnects from the local WiFi router 514 and re-establishes a connection to the remote server communication network and checks for any new information that has been uploaded to the server from one of the control system devices 502, 504, 506, etc. In one embodiment of the subject matter the auxiliary device may be imbedded within the same housing and powered from the same electrical supply as the remote server, but it may also be a standalone device, physically separated from the remote server, to better allow wireless communication with the consumer's WiFi router.

Environment 500 also contains a mobile computing device 510, such as a phone, tablet or in-home display, for the purpose of displaying information from the web server 508 for consumption by an end consumer or user. Information about operation of equipment operating in environment 500 may be processed by web server and displayed on the mobile computing device 510 to perform data analytics operations. The data analytics operations may be performed using one or more Machine Learning techniques. From the data analytics operations, operational timings, power consumption, and other operational patterns associated with equipment operating in environment 500, such as potential equipment failure, may be determined. Further, from the data analytics operations, data models can be trained to predict future values of such details. For example, the data models may predict a future time of activation of HVAC unit 16, or EV Charger 24, and power that may be consumed through the Power Supply 12 during such future time.

In one implementation, the breaker controller also connects with HVAC control 504, EV charger control 502, and Nth device controller 26 through a local wireless network established via the WiFi server 512. Based on the details related to operation of one equipment, breaker controller instructs a controller circuit for activation or deactivation of its associated equipment. For example, the breaker controller may instruct EV charger control 502 to not activate charging of EV 18 when it is identified that HVAC unit 16 is operating.

Although the above description is explained considering that the charger control system is used to control the charging of the EV while monitoring the operation of the HVAC, a person skilled in the art understands that any electric device within the home or any other set up can be controlled to optimize the energy utilization at home in a like manner.

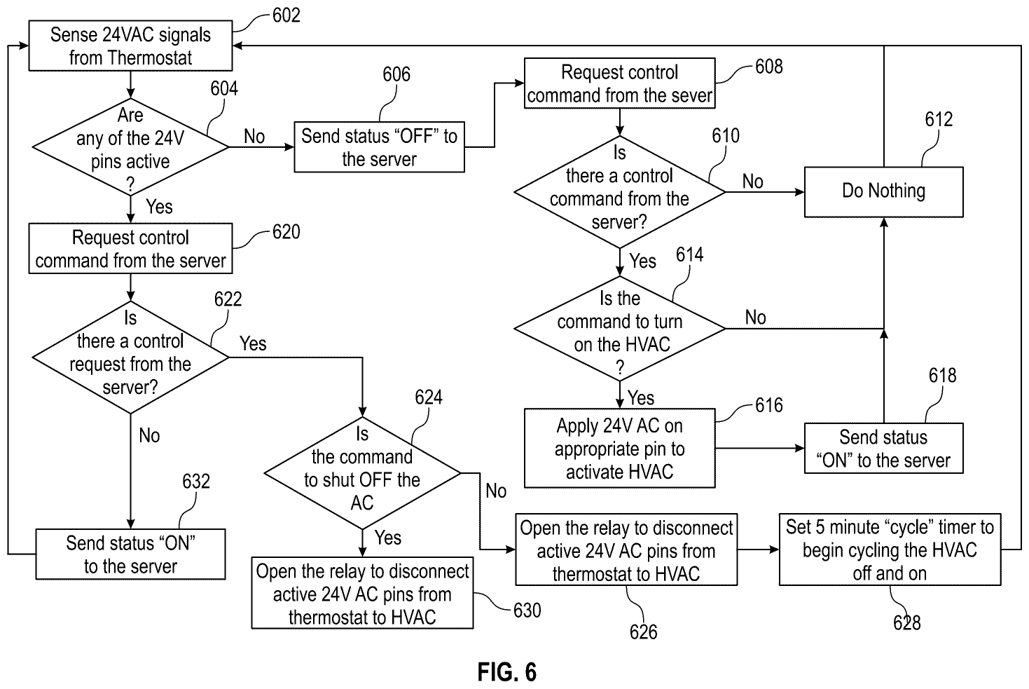

FIG. 6 shows a method 600 for sensing and controlling the HVAC system, in accordance with one embodiment of the present subject matter. The order in which method 600 is described should not be construed as a limitation, and any number of the described method blocks can be combined in any order to implement method 600 or alternate methods. Additionally, individual blocks may be deleted from method 600 without departing from the spirit and scope of the subject matter described herein. Furthermore, method 600 can be implemented in any suitable hardware, software, firmware, or combination thereof. However, for ease of explanation, in the embodiments described below, method 600 may be implemented using the above-described controller circuits, such as HVAC control 504.

Method 600 begins at step 602. At step 602, presence of 24V AC signals from a thermostat is sensed. Upon sensing the signal, it is determined if any 24V pin is active, at step 604. When an active status of any 24V AC pin isn't determined, an OFF status is sent to the remote server 512, at step 606. Thereafter, a control command is requested from the remote server 512, at step 608. Subsequently, receipt of a control command from the remote server is determined, at step 610. When receipt of the control command from the remote server is not determined, no action is taken, as shown at step 612. Alternatively, when receipt of the control command from the remote server is determined, it is determined if the control command is for turning ON the HVAC unit, at step 614. When it is determined that the control command isn't for turning ON the HVAC unit, no action is taken, at step 612. Alternatively, when it is determined that the control command is for turning ON the HVAC unit, 24V AC is provided on an appropriate pin to activate the HVAC unit, at step 616. After turning ON the HVAC unit, an ON status is sent to the remote server 512, at step 618.

At step 604, when the active status of any 24V AC pin is determined, a control command is requested from the remote server 512, at step 620. Subsequently, presence of a control request from the remote server is identified, at step 622. When the presence of the control request from the remote server is identified, it is determined if the control request/command is to shut OFF the HVAC unit, at step 624. When the command isn't for shutting OFF the HVAC unit, a relay supplying AC power to the AC pins is opened to disconnect the 24V AC pins from thermostat to the HVAC unit, at step 626. Subsequently, a five-minute cycle timer is set to begin cycling of the HVAC unit ON and OFF, at step 628. Thereafter, presence of 24V AC signals from the thermostat is sensed, at step 602. Alternatively, at step 624, when it is determined that the command is for shutting OFF the HVAC unit, the relay is opened to disconnect the 24V AC pins from the thermostat to the HVAC unit, at step 630. Further, at step 622, when receipt of any control request from the remote server isn't identified, an ON status is sent to the remote server 512, at step 632 and presence of 24V AC signals from the thermostat is sensed, at step 602.

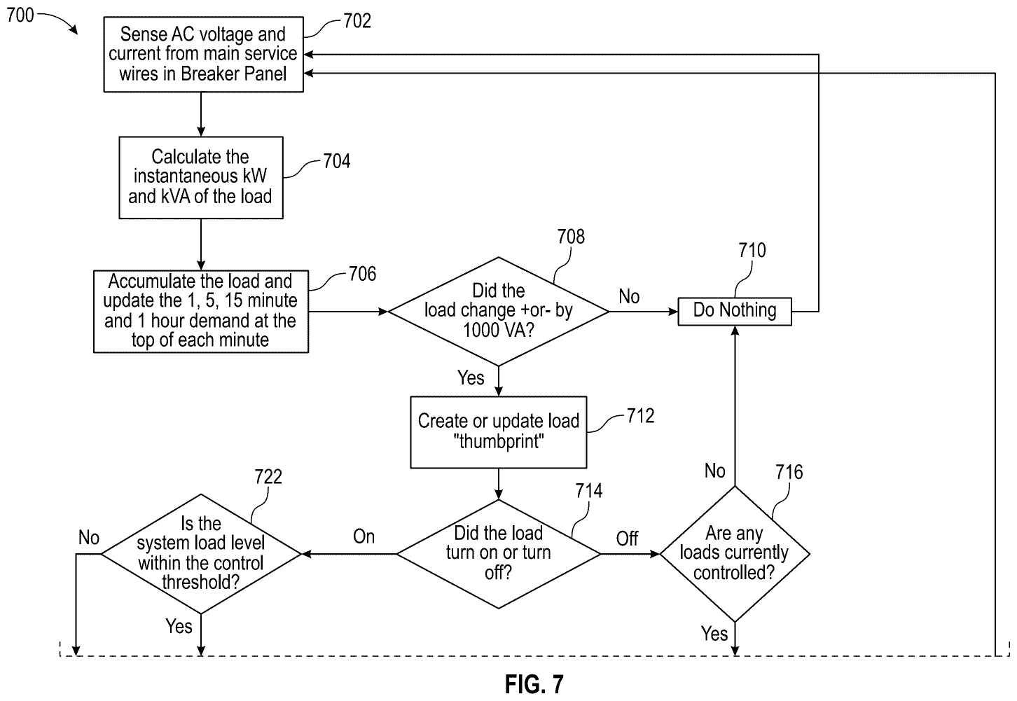

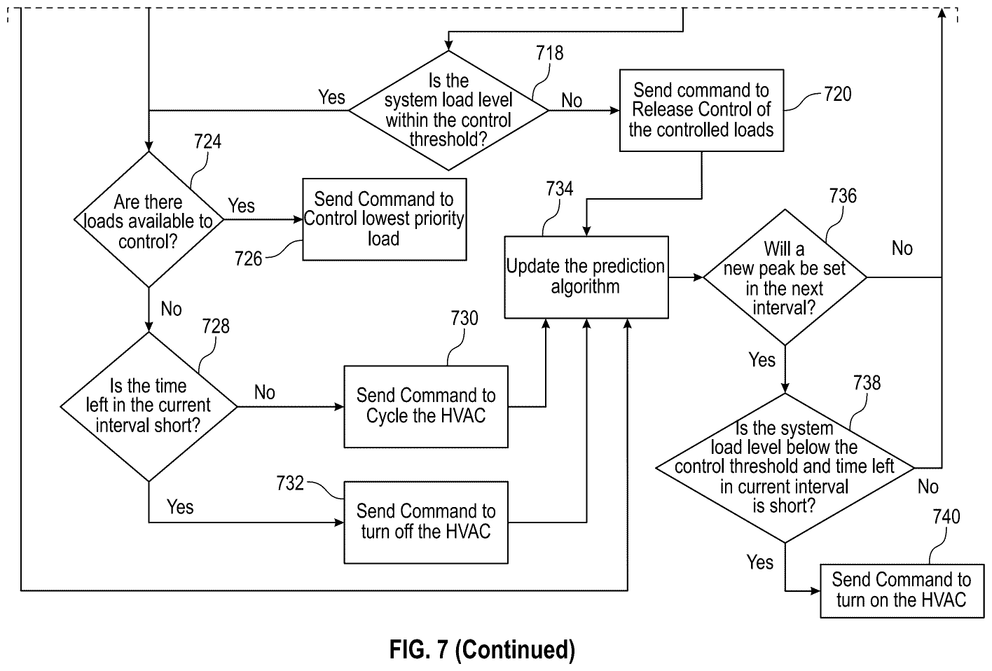

FIG. 7 shows a method 700 for managing the demand (i.e. average peak power consumption) in an environment, in accordance with the proposed embodiment of the present subject matter. For managing the average peak power consumption, energy demand is monitored at the breaker box, the analysis of the active and inactive loads and the development of control signals is monitored for controllable large loads such as the EV charger and HVAC. The order in which method 700 is described should not be construed as a limitation, and any number of the described method blocks can be combined in any order to implement method 700 or alternate methods. Additionally, individual blocks may be deleted from method 700 without departing from the spirit and scope of the subject matter described herein. Furthermore, method 700 can be implemented in any suitable hardware, software, firmware, or combination thereof. However, for ease of explanation, in the embodiments described below, method 700 may be implemented using the above-described controller circuits or the breaker panel sensor 28.

Method 700 begins at step 702. At step 702, AC voltage and current is sensed in the main service wires of the breaker panel. Thereafter, instantaneous power consumption in terms of kW and kVA is determined, at step 704. Load is accumulated and 1, 5, 15 minute and 1 hour demands are updated at top of each minute, at step 706. Subsequently, it is determined if the load increased or decreased by 1000 VA, at step 708. When it is determined that the load didn't increase or decrease by 1000 VA, no action is taken, at step 710. Alternatively, when it is determined that the load increased or decreased by 1000 VA, a load “thumbprint” is created or an existing thumbprint is updated, at step 712. Thereafter, it is determined if any load turned ON or OFF, at step 714. When any load does not turn ON or OFF, it is determined if any loads are already being controlled, at step 716. When no load is being controlled, no action is taken, at step 710. Alternatively, when any load is already being controlled, it is determined if the system load level is within a control threshold, at step 718. When the system load level is determined to be present beyond the control threshold, a command to release control of already controlled loads is sent, at step 720.

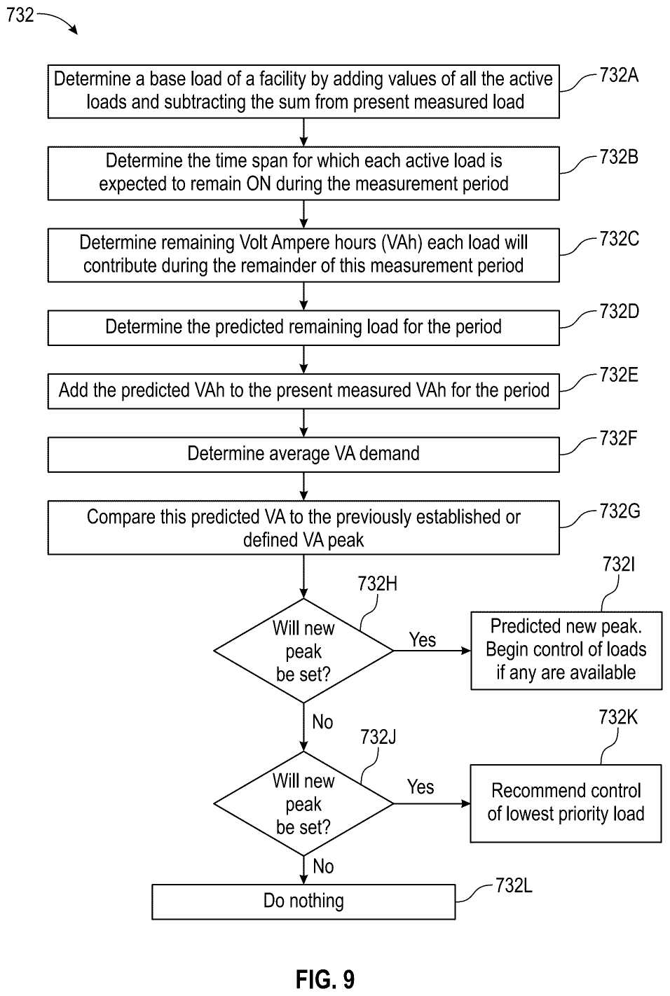

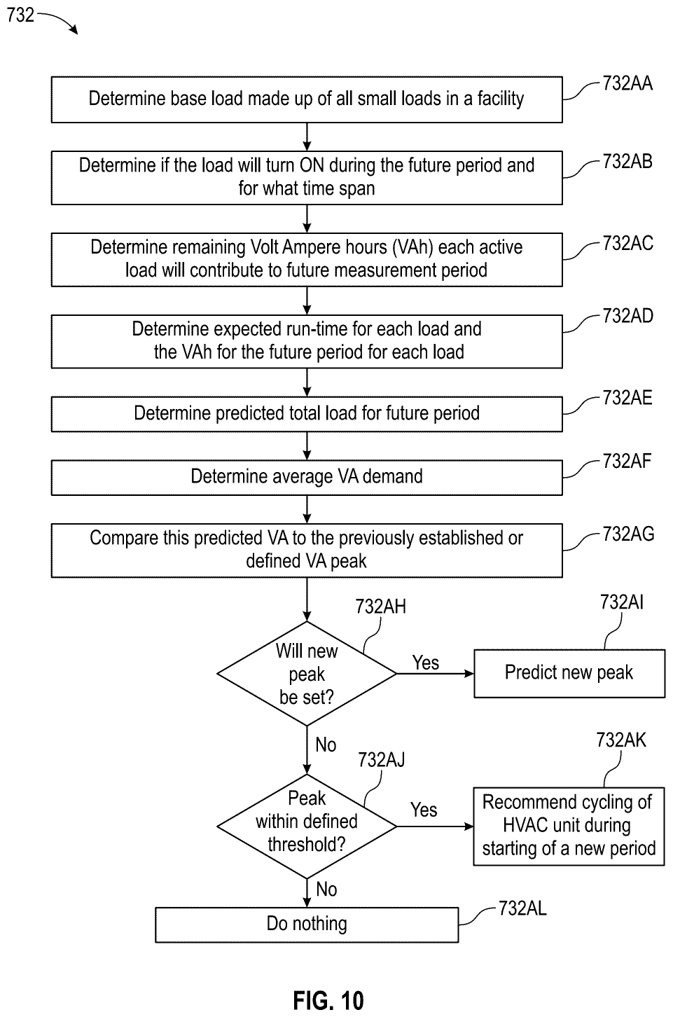

At step 722, when it is determined that the system load is within the control threshold, it is determined if there are other loads available to control, at step 724. When it is determined that there aren't any loads available to control, a command is sent to control a lowest priority load, at step 726. Alternatively, when it is determined that loads are available to control, it is determined whether time left in the current interval short i.e. less than a predefined time period, at step 728. When it is determined that the time left in the current interval isn't short, a command is sent to cycle the HVAC unit, at step 730. Alternatively, when it is determined that the time left in current interval is short, a command is sent to turn OFF the HVAC unit, at step 732. After steps 722, 730, and 732, a prediction algorithm is updated, at step 734. The detailed method of updating the prediction algorithm is described later with reference to FIG. 9 and FIG. 10. Subsequently, it is determined if a new peak will be set in the next time interval, at step 736. When it is determined that a new peak will not be set in the next time interval, AC voltage sensing from the main service wires is performed back, at step 702. Alternatively, when it is determined that a new peak will be set in the next time interval, it is determined if the system load level is below the control threshold and if the time left in current interval short, at step 738. When it is determined that the system load level is below the control threshold and if the time left in current interval short, a command is sent to turn ON the HVAC unit, at step 740. Alternatively, AC voltage sensing from the main service wires is performed back, at step 702.

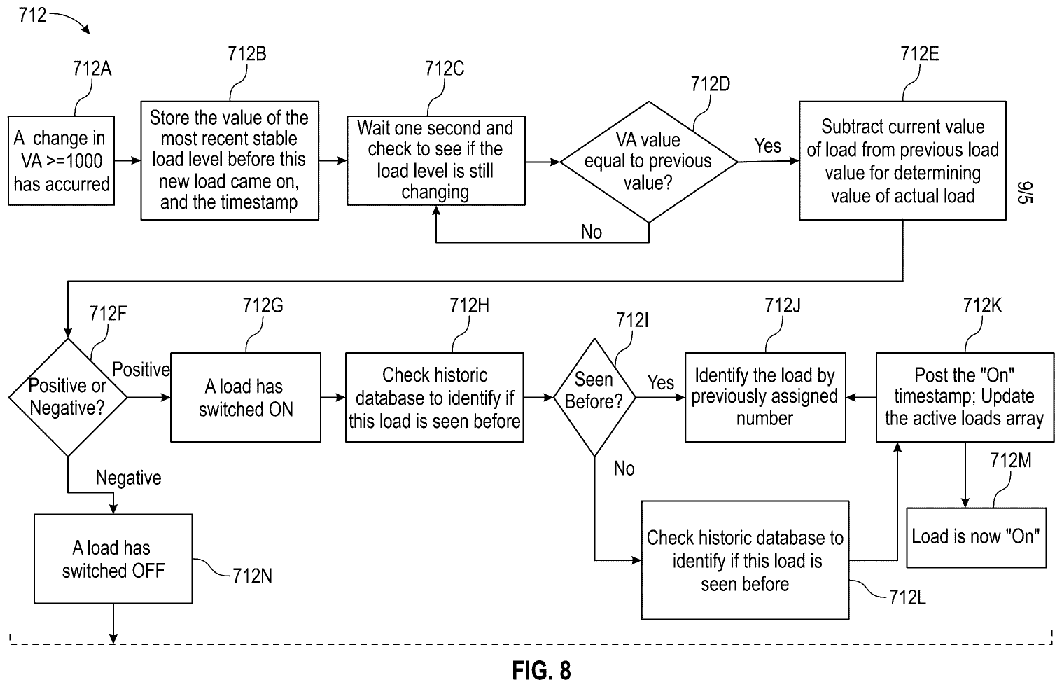

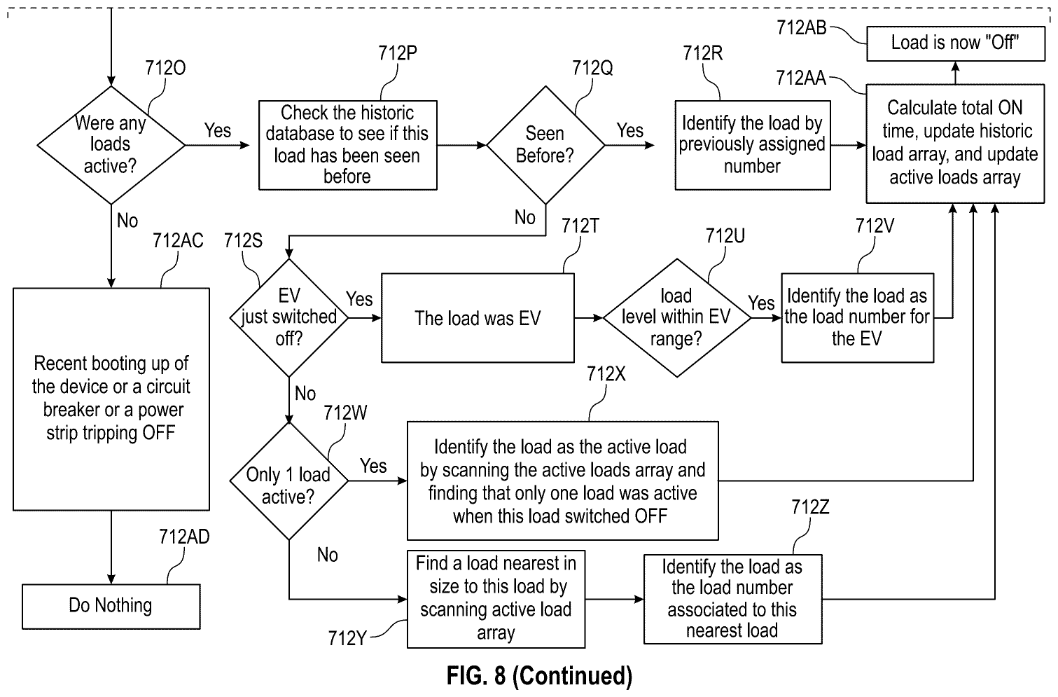

FIG. 8 shows a method 712 of creating and updating a load thumbprint, in accordance with one embodiment of the present subject matter. The order in which method 712 is described should not be construed as a limitation, and any number of the described method blocks can be combined in any order to implement method 712 or alternate methods. Additionally, individual blocks may be deleted from method 712 without departing from the spirit and scope of the subject matter described herein. Furthermore, method 712 can be implemented in any suitable hardware, software, firmware, or combination thereof.

Method 712 begins at step 712A where a change in VA greater than or equal to 1000 occurs. Thereafter, a value of a most recent and stable load and its timestamp before a current load is observed is stored, at step 712B. After waiting for one second, a change in the load level is determined, at step 712C. At step 712D, it is determined if the VA value is equal to a previous value. When the VA value is not identified to be equal to the previous value, it is again determined if the load level is changing, after waiting for one second, at step 712C. Alternatively, when it is determined that the VA value is equal to the previous value, current value of load is subtracted from previous load value for determining value of actual load, at step 712E. In this manner, loads that are either gradual or instantaneous upon switching ON or OFF are determined.

At step 712F, it is determined if the difference between the current value of load and previous load value is positive or negative. When the difference is determined to be positive, it is identified that a load has switched ON, at step 712G. Thereafter, the historic database is checked to identify if this load is seen before, at step 712H. At step 712I, when it is determined that the load is seen before also, the load is identified by a number previously assigned to it, at step 712J. Thereafter, an ON timestamp is posted and an active loads array is updated to store details of the load, at step 712K. At step 712I, when it is determined that the load is not seen before, a new load entry is initialized in the historic database and a unique number is assigned to the load, at step 712L. At step 712L, it is also determined if the load is instantaneous or gradual. Thereupon, the ON timestamp is posted and the active loads array is updated to store details of the load, at step 712K, and it is identified that the load is turned ON, at step 712M.

At step 712F, when the difference between the current value of load and the previous load value is determined to be negative, it is identified that a load has switched OFF, at step 712N. Subsequently, at step 712O, it is determined if any loads were previously active. When it is determined that one or more loads were previously active, the historic database is checked to identify if the load was seen before, at step 712P. At step 712Q, when it is determined that the load was seen before, the load is identified by a previously assigned number, at step 712R. Alternatively, at step 712Q, when it is determined that the load wasn't seen before, it is checked if the EV switched OFF just now, at step 712S. When it is determined that the EV switched OFF just now and the load was less than or equal to the active load for the EV, it is identified that the load was the EV, at step 712T. Then, at step 712U, it is checked if the load level is within the EV range. When the load level is identified to be present within the EV range, the load is identified as a load number for the EV, at step 712V. At step 712S, when it is determined that the EV didn't switch OFF recently, it is determined if only one load is active, at step 712W. When only one load is identified to be active, the active loads array is scanned to check if only one load was active when this load switched OFF. If found true, the load is identified as the active load, at step 712X. Alternatively, when more than one load is found to be active, the active loads array is scanned for finding the load that is nearest in size to this load, at step 712Y. The load is then identified with the load number associated with the nearest load, at step 712Z. After steps 712V, 712X, and 712Z, a total ON time is calculated and historic load array and active loads array are updated, at step 712AA. At step 712AB, it is concluded that the load is OFF now. At step 712O, when it is identified that no loads were active, it may be concluded at step 712AC that the negative load value determined at step 712F corresponds to recent booting up of the device or a circuit breaker or a power strip tripping OFF that includes many small loads on it. Thereafter, no action would be taken, at step 712AD.

FIG. 9 shows a method 732 of active period prediction using a prediction algorithm, in accordance with one embodiment of the present subject matter. The order in which method 732 is described should not be construed as a limitation, and any number of the described method blocks can be combined in any order to implement method 732 or alternate methods. Additionally, individual blocks may be deleted from method 732 without departing from the spirit and scope of the subject matter described herein. Furthermore, method 732 can be implemented in any suitable hardware, software, firmware, or combination thereof.

Method 732 begins at step 732A. At step 732A, values of all the active loads are added, and the sum is subtracted from the load measured. The value obtained through subtraction is identified as a base load that is made up of all the smaller loads in the facility. For prediction, it is assumed that these loads will remain turned ON. At step 732B, the time span for each active load expected to remain ON during the measurement period is determined. Such time span is determined based on the timestamp when the load turned ON and the historic average run-time of the load. At step 732C, the remaining Volt Ampere hours (VAh) each load will contribute during the remainder of this measurement period is determined. The remaining VAh is determined by multiplying the remaining estimated run-time for each load with the load size. At step 732D, the predicted remaining load for the period is determined by multiplying the remaining time in the period with the base load and the product is added to the previously calculated active load VAh. At step 732E, the predicted VAh is added to the present measured VAh for the period. At step 732F, average VA demand is determined by estimating a sum of the loads and dividing the sum by a length of the period. The sum of loads is the estimated VAh for the measuring period. At step 732G, the predicted VA value is compared with the previously established or defined VA peak. At step 732H, it is determined if a new peak will be set. When it is determined that a new peak will be set, the new peak is predicted and control of available loads is begun, at step 732I. Alternatively, when it is determined that a new peak won't be set, it is determined if the predicted VA/peak is present within a defined threshold, at step 732J. When the peak is identified to be present within the defined threshold, control of a lowest priority load is initiated, at step 732K. Alternatively, no action is taken as controlling is unnecessary, at step 732L.

FIG. 10 shows a method 732 of future period prediction using a prediction algorithm, in accordance with one embodiment of the present subject matter. The order in which method 732 is described should not be construed as a limitation, and any number of the described method blocks can be combined in any order to implement method 732 or alternate methods. Additionally, individual blocks may be deleted from method 732 without departing from the spirit and scope of the subject matter described herein. Furthermore, method 732 can be implemented in any suitable hardware, software, firmware, or combination thereof.

Method 732 begins at step 732AA. At step 732AA, values of all the active loads are added, and the sum is subtracted from the load measured. The values obtained through subtraction are identified as the base load that is made up of all the smaller loads in the facility. For prediction, it is assumed that these loads will remain turned ON. At step 732AB, it is determined if the load will turn ON during the future period and for what time span. Such time span is determined based on the historic on-time and the historic average run-time of the load. At step 732AC, the remaining Volt Ampere hours (VAh) each currently active load will contribute to the future measurement period is determined. The remaining VAh is determined by multiplying the remaining estimated run-time (based on historic run-time and the time the load most recently came on) for each load with the load size. At step 732AD, expected run-time for each load and the VAh for the future period for each load are determined. Such factors are determined by scanning the historic load data and identifying which loads usually turn ON in the future period.

At step 732AE, the predicted total load for the future period is determined by multiplying the full time in the future period with the base load in the active period and adding the product with the previously calculated active and predicted load VAh. At step 732AF, average VA demand is determined by estimating a sum of the loads and dividing the sum by a length of the period. The sum of loads is the estimated VAh for the measuring period. At step 732AG, the predicted VA value is compared with the previously established or defined VA peak. At step 732AH, it is determined if a new peak will be set. When it is determined that a new peak will be set, the new peak is predicted, at step 732AI. Additionally, pre-loading the facility with heating or cooling is recommended based on the appropriate season. Alternatively, at step 732AH, when it is determined that a new peak won't be set, it is determined if the predicted VA/peak is present within a defined threshold, at step 732AJ. When the peak is identified to be present within the defined threshold, cycling of the HVAC unit is recommended during the starting of a new period, at step 732AK. Alternatively, no action is taken as controlling is unnecessary, at step 732AL.

From the above provided details of FIG. 9 and FIG. 10, it must be understood that the future period prediction is very similar to the active period prediction, only the historic data is scanned to determine if any loads are known to turn ON during that period of time, and their typical run-times when they do turn ON. This data is used along with the active period's measured base load. The active period's HVAC duty cycle and the historic average HVAC duty cycle for the period in question is also utilized to calculate the amount of load estimated during the period immediately following the current measurement period.

The presently disclosed charge control system provides several advantages over prior art. For example, the server determines the operation status of all equipment in the home, and controls either operation of the HVAC, the EV Charger, or both in order to manage energy demand in the home. The EV charger control proposed in the present invention are agnostic to any equipment, for example the EV charger control can function to manage power consumption by any EV and with any charger. Further, the breaker sensor helps to monitor loading information and collect statistical data about the individual loads for the purpose of performing statistical analysis and use the results to determine control commands for controlling operational status of equipment within the home. Local wireless network is used by each controller circuit to communicate with the server. This is because the local wireless network is created by the server and it cannot be hacked by an unauthorized person and eliminates dependency on consumer Wi-Fi. Because operation of the proposed system is dependent on described hardware elements and not on internet based software programs, the system is more reliable and not subject to disturbances in consumer internet access.

In the above description, numerous specific details are set forth such as examples of some embodiments, specific components, devices, methods, in order to provide a thorough understanding of embodiments of the present subject matter. It will be apparent to a person of ordinary skill in the art that these specific details need not be employed, and should not be construed to limit the scope of the subject matter.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the invention, it is intended that all matter contained in the above description or shown in the accompanying drawings shall be interpreted as illustrative and not in a limiting sense.

It will be apparent to those skilled in the art that various modifications and variations can be made in the present disclosure without departing from the scope or spirit of the disclosure. Other embodiments of the disclosure will be apparent to those skilled in the art from consideration of the specification and practice of the disclosure disclosed herein. It is intended that the specification and examples be considered as exemplary only, with a true scope and spirit of the disclosure.

What is claimed is:

1. I claim all of the above subject matter.
